(19) United States
(12) Patent Application Publication
(10) Pub. No.: US 2017/0012578 A1
(43) Pub. Date: Jan. 12, 2017

(54) SOLAR PANEL HEAT REMOVAL SYSTEM AND ASSOCIATED METHOD

(71) Applicant: SunCulture Solar, Inc., Mountain View, CA (US)

(72) Inventor: Christopher A. Estes, Mountain View, CA (US)

(21) Appl. No.: 15/271,396

(22) Filed: Sep. 21, 2016

Related U.S. Application Data
(63) Continuation-in-part of application No. 15/260,477, filed on Sep. 9, 2016.
Application No. 15/260,477 is a continuation of application No. 13/843,573, filed on Mar. 15, 2013, now Pat. No. 9,444,397.
(60) Provisional application No. 61/719,140, filed on Oct. 26, 2012.

(51) Int. Cl. H02S 40/42; H02S 20/32; H02S 40/38

(52) U.S. Cl. CPC H02S 40/425; H02S 40/38; H02S 20/32

(57) ABSTRACT

A solar panel and associated method of removing heat from a solar panel are disclosed. The solar panel includes a housing, a heat shield, and a plurality of solar cells. The housing includes a front surface, a back surface disposed opposite the front surface, an air inlet configured to allow air to enter the housing, an air outlet configured to allow the air to exit the housing, and a first air channel fluidly communicating with the air inlet and the air outlet. The first air channel is disposed within the housing between the heat shield and the front surface. The heat shield is disposed within the housing and is configured to reduce heat transfer between the front and back surfaces of the housing. The plurality of solar cells are disposed adjacent the front surface of the housing.

### CROSS-REFERENCE TO RELATED APPLICATIONS

The present application is a continuation-in-part of and claims the benefit of U.S. patent application Ser. No. 15/260,477, filed Sep. 9, 2016, which is a continuation of and claims the benefit of U.S. patent application Ser. No. 13/843,573, filed Mar. 15, 2013, now U.S. Pat. No. 9,444,397 issued Sep. 13, 2016, which claims the benefit of U.S. Provisional Patent Application No. 61/719,140, filed Oct. 26, 2012, the entire disclosures of which are expressly incorporated by reference herein.

### BACKGROUND

Field of Disclosure

The present disclosure relates generally to solar panels, and more particularly, to the removal of waste heat from solar panels.

Related Art

It is desirable that a solar panel, and its internal components, remain cool both while generating solar energy and when consuming solar energy stored within a battery or other source. However, this is difficult without the use of additional electrical components, such as electrically powered fans. As a result, solar panels may get hotter than desired either when generating solar energy or when consuming solar energy stored within a battery.

Therefore, it would be desirable to remove heat from a solar panel without the use of electrically powered components, thereby enabling the solar panel to remain cool both when generating solar energy and when consuming solar energy stored within a battery.

### SUMMARY

In accordance with one embodiment, a solar panel includes a housing, a heat shield, and a plurality of solar cells. The housing includes a front surface, a back surface disposed opposite the front surface, an air inlet configured to allow air to enter the housing, an air outlet configured to allow the air to exit the housing, and a first air channel fluidly communicating with the air inlet and the air outlet. The heat shield is disposed within the housing and is configured to reduce heat transfer between the front and back surfaces of the housing. The plurality of solar cells are disposed adjacent the front surface of the housing. The first air channel is disposed within the housing between the heat shield and the front surface.

In various embodiments, electronics and a plurality of batteries are disposed between the heat shield and the back surface. A second air channel, fluidly communicating with the air inlet and the air outlet, is disposed between the heat shield and the back surface. The second air channel is configured to dissipate heat from the electronics and the plurality of batteries through the air outlet.

In various embodiments, the first air channel extends in a direction generally parallel to both the heat shield and the plurality of solar cells. The first air channel may preferably extend along at least 50% of the lengthwise direction of the solar panel, and more preferably along at least 75% of the lengthwise direction of the solar panel.

In accordance with yet another aspect of the present invention, a method of removing heat from a solar panel is described. The solar panel includes a housing including a front surface, a back surface disposed opposite the front surface, an air inlet and an air outlet, and a plurality of solar cells disposed adjacent the front surface of the housing. The method includes positioning a heat shield within the housing to reduce the heat transfer between the front and back surfaces. The method also includes intaking air through the air inlet into the first air channel disposed between the heat shield and the plurality of solar cells. The method also includes flowing the air through the first air channel causing the air to increase in temperature. The method also includes exhausting the air from the first air channel through the air outlet to dissipate heat from the plurality of solar cells.

These and other objects and advantages of the disclosed apparatus will become more readily apparent during the following detailed description taken in conjunction with the drawings herein.

### BRIEF DESCRIPTION OF THE DRAWINGS/FIGURES

Embodiments of the present disclosure are described with reference to the accompanying drawings. In the drawings, like reference numerals indicate identical or functionally similar elements. Additionally, the left most digit(s) of a reference number typically identifies the drawing in which the reference number first appears.

FIG. 1 is a top-elevational view of an exemplary solar panel according to an exemplary embodiment of the present disclosure.

FIG. 2 is a top-elevational view of a solar panel configuration according to an exemplary embodiment of the present disclosure.

FIG. 3 is a block diagram of an exemplary solar panel that tray be used in the solar panel configuration according to an exemplary embodiment of the present disclosure.

FIG. 4A is a block diagram of an exemplary solar panel that may be used in the solar panel configuration according to an exemplary embodiment of the present disclosure.

FIG. 4B is a block diagram of an exemplary solar panel that may be used in the solar panel configuration according to one exemplary embodiment of the present disclosure.

FIG. 5 is a block diagram of an exemplary solar panel that may be used in the solar panel configuration according to an exemplary embodiment of the present disclosure.

FIG. 6 is a block diagram of an exemplary solar panel configuration according to an exemplary embodiment of the present disclosure.

FIG. 7 illustrates a wireless solar panel configuration.

FIG. 8 is a flowchart of exemplary operational steps of the solar panel according to an exemplary embodiment of the present disclosure.

FIG. 9 is a cross-sectional side view of a solar panel according to an exemplary embodiment of the present disclosure.

FIG. 10 is a first thermal image of the back surface of the solar panel just after being removed from the sunlight.

FIG. 11 is a second thermal image of the back surface of the solar panel at a period of time after FIG. 10.

FIG. 12 is a cross-sectional perspective view of a solar panel according to an exemplary embodiment of the present disclosure.

FIG. 13 is a cross-sectional perspective view of the solar panel of FIG. 12 taken from another perspective.

The present disclosure will now be described with reference to the accompanying drawings. In the drawings, like reference numbers generally indicate identical, functionally similar, and/or structurally similar elements.

### DETAILED DESCRIPTION OF THE PRESENT DISCLOSURE

The following Detailed Description refers to accompanying drawings to illustrate exemplary embodiments consistent with the present disclosure. References in the Detailed Description to “one exemplary embodiment,” “an exemplary embodiment,” an “example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic may be described in connection with an exemplary embodiment, it is within the knowledge of those skilled in the art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the present disclosure. Therefore, the Detailed Description is not meant to the present disclosure. Rather, the scope of the present disclosure is defined only in accordance with the following claims and their equivalents.

Embodiments of the present disclosure may be implemented in hardware, firmware, software, or any combination thereof. Embodiments of the present disclosure may also be implemented as instructions supplied by a machine-readable medium, which may be read and executed by one or more processors. A machine-readable medium may include any mechanism for storing or transmitting information in a form readable by a machine (e.g., a computing device). For example, a machine-readable medium may include read only memory (“ROM”), random access memory (“RAM”). magnetic disk storage media, optical storage media, flash memory devices, electrical optical, acoustical or other forms of propagated signals (e.g., carrier waves, infrared signals, digital signals, etc.), and others. Further firmware, software routines, and instructions may be described herein as performing certain actions. However, it should be appreciated that such descriptions are merely for convenience and that such actions in fact result from computing devices, processors, controllers, or other devices executing the firmware, software, routines, instructions, etc.

For purposes of this discussion, each of the various components discussed may be considered a module, and the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the present disclosure that others can, by applying knowledge of those skilled in the relevant art(s), readily modify and/or adapt for various applications such exemplary embodiments, without undue experimentation, without departing from the spirit and scope of the present disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

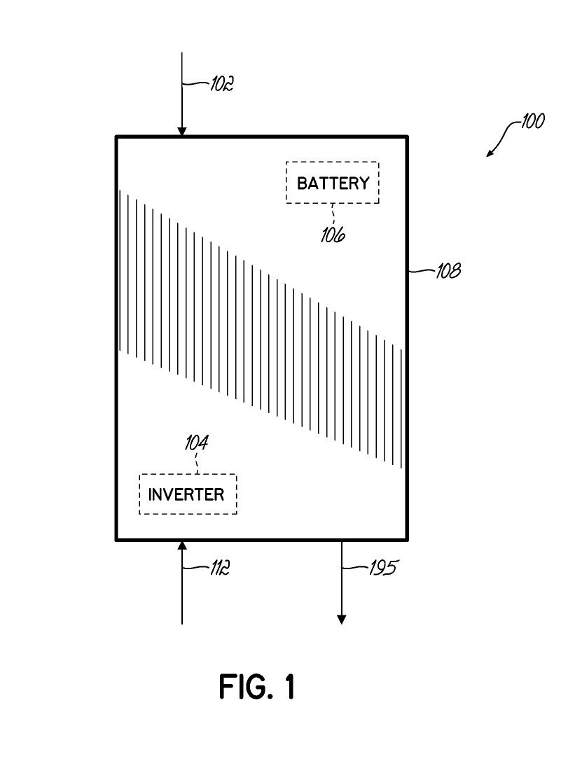

FIG. 1 illustrates a top-elevational view of an exemplary solar panel according to an exemplary embodiment of the present disclosure. The solar panel 100 is configured to collect energy 102 from a light source, such as the sun, and convert that energy with an inverter 104 into DC power and if desired, store that power in a battery 106 or other power storage device. A solar panel 100 may additionally be a standalone AC power generating device by converting or inverting the DC power to AC power. However, the solar panel 100 is not limited to generating output AC power 195 by passing through input AC power 112 received from a utility grid into the output AC power 195 when the solar panel 100 is coupled to the utility grid. Rather, the solar panel 100 may still generate standalone output AC power 195 when isolated from the utility grid, i.e., not grid tied.

The solar panel 100 may also receive input AC power 112 that is generated by an electric utility grid when the solar panel 100 is coupled to the grid, i.e. when it is grid tied. In such cases, the solar panel 100 may parallel the AC output power 195 generated from the inverted DC power provided by a DC battery 106 with the input AC power 112 when the output AC power 195 is synchronized with the input AC power 112. The input AC power 112 may also be generated by a second solar panel 100 when it is coupled to a first solar panel 100, by an AC power generator, an AC power inverter, a sinusoidal AC power inverter, and/or any other type of AC power source independent from the solar panel 100 that will be apparent to those skilled in the relevant art(s) without departing from the spirit and scope of the disclosure.

The solar panel 100 may generate the output AC power 195 that is in parallel with the input AC power 112 when the output AC power 195 is synchronized with the input AC power 112. The solar panel 100 may sense the input AC power 112 when the solar panel 100 is coupled to a power source. The solar panel 100 may also sense the input AC power 112 when the solar panel 100 is coupled to the second solar panel and the second solar panel is providing the input AC power 112 to the solar panel 100.

The solar panel 100 may determine whether the input AC power 112 is synchronized with the output AC power 195 based on the power signal characteristics of the input AC power 112 and the output AC power 195. The power signal characteristics are characteristics associated with the sinusoidal waveform included in the input AC power 112 and the output AC power 195. The solar panel 100 may generate the output AC power 195 that is in parallel with the input AC power 112 when the power signal characteristics of the input AC power 112 are within a threshold of the power signal characteristics of the output AC power 195 so that the input AC power 112 and the output AC power 195 are synchronized. The solar panel 100 may refrain from generating the output AC power 195 that is in parallel with the input AC power 112 when the power signal characteristics of the input AC power 112 are outside the threshold of the power signal characteristics of the output AC power 195 where the input AC power 112 and the output AC power 195 are not synchronized.

For example, the solar panel 100 determines whether the input AC power 112 and the output AC power 195 are synchronized based on the frequency and the voltage of the sinusoidal waveform included in the input AC power 112 and the frequency and the voltage of the sinusoidal waveform included in the output AC power 195. The solar panel 100 generates the output AC power 195 that is in parallel with the input AC power 112 when the frequency and the voltage of the input AC power 112 are within the threshold of 10% from the frequency and the voltage of the output AC power 195 so that the input AC power 112 and the output AC power 195 are synchronized. The solar panel 100 refrains from generating the output AC power 195 that is in parallel with the input AC power 112 when the frequency and the voltage of the input AC power 112 are outside the threshold of 10% from the frequency and the voltage of the output AC power 195 where the input AC power 112 and the output AC power 195 are not synchronized. Rather, the solar panel 100 generates the output AC power 195 that is generated from the DC source and refrains from combining the output AC power 195 with the input AC power 112.

The power signal characteristics may include but are not limited to frequency, phase, amplitude, current, voltage and/or any other characteristic of a power signal that will be apparent to those skilled in the relevant art(s) without departing from the spirit and scope of the disclosure. The solar panel 100 may store the power signal characteristics of the input AC power 112. The threshold of the power signal characteristics associated with the input power as compared to the output power may be any threshold that prevents damage from occurring to the power converter 100 by combining the input AC power 112 and the output AC power 195 when the power signal characteristics of each significantly differ resulting in damage that will be apparent to those skilled in the relevant art(s) without departing from the spirit and scope of the disclosure.

In short, the output AC power 195 generated by the solar panel 100 may be used to power electronic devices external to the solar panel 100, such as a hairdryer, for example. The output AC power 195 may also be provided to another solar panel. The solar panel 100 may also convert the input AC power 112 to DC power and store the DC power within to the solar panel 100. The solar panel 100 may continue to provide standalone output AC power 195 even after it is no longer receiving AC input power 112. Thus the solar panel 100 is not reliant on external sources to generate output AC power 195. For example, the solar panel 100 may continue to provide standalone output AC power 195 after it is no longer grid tied, or after it is no longer receiving AC input power 112 from another solar panel. For example, the solar panel 100 continues to provide output AC power 195 that is not in parallel with the input AC power 112 after the power converter 100 is no longer coupled to a power source such that the solar panel 100 is no longer receiving the input AC power 112 from the power source. In another example, the solar panel 100 continues to provide output AC power 195 that is not in parallel with the input AC power 112 after the solar panel 100 is no longer receiving the input AC power 112 from the second solar panel.

The solar panel 100 will also sense when it is no longer receiving AC input power 112. The solar panel 100 may then internally generate the standalone output AC power 195 from the previously stored DC power. For example, the solar panel 100 may have previously stored DC power that was converted from the input AC power 112 or that was converted from the solar energy 102.

The solar panel 100 may internally generate the output AC power 195 by converting the previously stored DC power into the output AC power 195. In one embodiment, the solar panel 100 may synchronize the power signal characteristics of the output AC power 195 that was converted from the previously stored DC power to be within the threshold of the power signal characteristics of the input AC power 112 despite no longer receiving the input AC power 112. For example, the solar panel 100 synchronizes the output AC power 195 that was converted from the previously stored DC power to have frequency and voltage that is within a threshold of 10% from the input AC power 112 when the solar panel 100 was receiving the input AC power 112. The solar panel 100 then provides the output AC power 195 when the solar panel 100 is no longer receiving the input AC power 112 while providing such output AC power 195 with frequency and voltage that is within the threshold of 10% from the previously received input AC power 112.

The solar panel 100 may be scalable in size and may be able to provide various levels of output power. For example, the solar panel 100 may be a portable model that may output approximately 250 W. In another example, the solar panel 100 may be a permanent rooftop model that may output 2.5 kW.

The solar panel 100 is also efficient in that it includes all of the components required to generate output AC power 195 within a single housing 108. For example, as will be discussed in more detail below, a solar power collector, a battery bank, a DC to AC converter, a controller, and other necessary components required to generate output AC power 195 are located within a single housing. This minimizes the amount of cabling required for the solar panel 100 so that transmission loss is minimized.

The solar panel 100 is also user friendly in that an individual may find that operating it requires relatively minimal effort. For example, as will be discussed in more detail below, the individual simply plugs in an external electrical device into the outlet provided on the solar panel 100 to power the external electrical device. In another example, the individual simply plugs in an additional solar panel into the outlet provided on the solar panel 100 to daisy chain the additional solar panel together. In yet another example, the solar panel 100 that is daisy chained to additional solar panels automatically establishes a master slave relationship so that the individual is not required to manually designate which is the master and the slave.

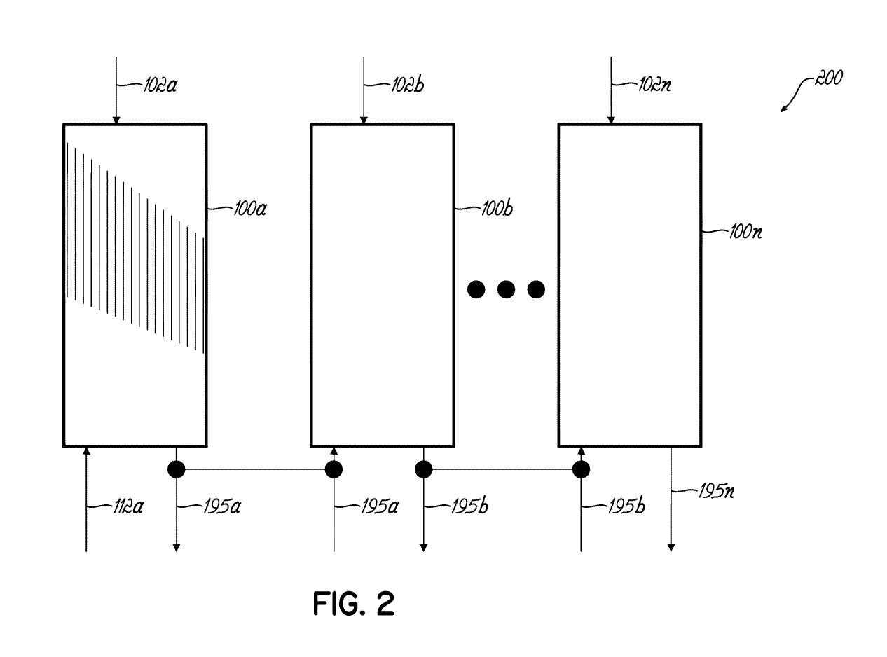

FIG. 2 illustrates a top-elevational view of a solar panel configuration according to an exemplary embodiment of the present disclosure. The solar panel configuration 200 represents a solar panel configuration that includes a plurality of solar panels 100a through 100n that may be daisy chained together to form the solar panel configuration 200, where n is an integer greater than or equal to two. Each solar panel 100a through 100n that is added to the solar panel configuration 200 may generate output AC power 195n that is in parallel with output AC power 195a, 195b. The solar panel configuration 200 shares many similar features with the solar panel 100 and as such, only the differences between the solar panel configuration 200 and the solar panel 100 will be discussed in further detail.

As noted above, the solar panel 100a generates output AC power 195a. However, the solar panel 100a is limited to a maximum output power level for the output AC power 195a. For example, the solar panel 100a may be limited to a maximum output power 195a level of 500 Watts (“W”). hence, regardless of the AC input power 112a level, the maximum output AC power 195a will be 500 W. Thus, if an individual desires, for example, to power a hair dryer that requires 1500 W to operate, the solar panel 100a will not be able to power it.

However, a user could daisy chain additional solar panels 100b through 100n together to parallel the output AC power 195a so that the overall output power of the solar panel configuration 200 is increased. In daisy chaining the plurality of solar panels 100a through 100n, each power input for each solar panel 100b through 100n is coupled to a power output of a solar panel 100b through 100n that is ahead of the solar panel 100b through 100n in the daisy chain configuration. For example, the power input of the solar panel 100b is coupled to the power output of the solar panel 100a so that the input AC power 195a received by the solar panel 100b is substantially equivalent to the output AC power 195a of the solar panel 100a. The power input of the solar panel 100n is coupled to the power output of the solar panel 100b so that the input AC power 195b received by the solar panel 100n is substantially equivalent to the output AC power 195b of the solar panel 100b.

After daisy chaining each of the plurality of solar panels 100(a-n), each output AC power 195(a-n) may be paralleled with each input AC power 112a, 112b, and/or 112n to increase the overall output AC power of the solar panel configuration 200. Each output AC power 195(a-n) may be paralleled with each input AC power 112a, 112b, and 112n so that the overall output AC power of the solar panel configuration 200 may be used to power the external electronic device that the individual requests to operate, such as the hair dryer. The individual may access the overall output AC power by coupling the external electronic device that the individual requests to power, such as the hair dryer, into any of the solar panels 100(a-n). The individual is not limited to coupling the external electronic device into the final solar panel 100n in the solar panel configuration 200 in order to access the overall output AC power. Rather, the individual may access the overall output AC power by coupling the external electronic device to any of the solar panels 100(a-n) in the solar panel configuration 200.

For example, if the maximum output AC power 195a for the solar panel 100a is 500 W, the maximum output power that can be generated by the solar panel 100b is also 500 W. The maximum output power that can be generated by the solar panel 100n is also 500 W. However, the solar panel 100b is daisy chained to the solar panel 100a and the solar panel 100b is daisy chained to the solar panel 100n. As a result, the external input AC power 112a, 112b, and 112n for each of the solar panels 100(a-n) is in parallel with the output AC power 195a, 195b, and 195n for each of the solar panels 100(a-n).

The output AC power 195a, 195b, and 195n for each of the solar panels 100(a-n) is 500 W. The solar panel 100b generates the output AC power 195b of 500 W in parallel with the input AC power 112b of 500 W so that the output AC power 195b and/or the output AC power 195a is the paralleled AC output power of 1000 W when the solar panel 100b is daisy chained to the solar panel 100a. The solar panel 100n is then daisy chained to the solar panels 100a and 100b so that the output AC power 195a, the output AC power 195b and/or the output AC power 195n is the paralleled AC output power of 1500 W. Thus, the maximum output AC power for the solar panel configuration 200 is 1500 W. The maximum output AC power of 1500 W is now sufficient to power the hair dryer that requires 1500 W to operate.

The individual may plug the hair dryer into any of the solar panels 100(a-n) in order to access the maximum output AC power of 1500 W generated by the solar panel configuration 200 to power the hair dryer. The individual is not limited to plugging the hair dryer into the solar panel 100n simply because the solar panel 100n is the last solar panel in the daisy chain of the solar panel configuration 200. The daisy chaining of each of the plurality of solar panels 100(a-n) when the plurality of solar panels 100(a-n) are not coupled to a power source but generating paralleled output AC power may be considered a standalone solar panel micro grid.

Each of the solar panels 100a through 100n included in the solar panel configuration 200 may operate in a master/slave relationship with each other. The master is the originator of the standalone AC power for the solar panel configuration 200. The master determines the power signal characteristics of the standalone AC power originated by the master in that each of the remaining slaves included in the solar panel configuration 200 are required to accordingly synchronize each of their own respective AC output powers. Each respective AC power output that is synchronized to the master standalone AC is paralleled with the master standalone AC power for the master. For example, the utility grid is the master of the solar panel configuration 200 when the utility grid is the originator of the input AC power 112a provided to solar panel 100a. The utility grid determines the frequency, phase, amplitude, voltage and current for the input AC power 112a. Each solar panel 100a through 100n then become slaves and synchronize each of their respective output AC power 195a through 195n to have substantially equivalent frequency, phase, amplitude, and current as the input AC power 112a. Each output AC power 195a through 195n that is synchronized with input AC power 112a is paralleled with the input AC power 112a.

Each of the solar panels 100a through 100n operates as a slave for the solar panel configuration 200 when each of the solar panels 100a through 100n is receiving input AC power. Each of the solar panels 100a through 100n operates as a master when each of the solar panels 100a through 100n no longer receives input AC power. For example, each of the solar panels 100a through 100n operate as the slave when the solar panel configuration 200 is grid tied so that the utility grid operates as the master for the solar panel configuration 200. Each solar panels 100a through 100n receives input AC power from either the grid or its adjacent panel. Solar panel 100a is receiving the input AC power 112a from the grid making solar panel 100a the slave while solar panel 100b receives the input AC power 195a from solar panel 100a making solar panel 100b the slave, etc.

In another example, solar panel 100a operates as the master for the solar panel configuration 200 when the solar panel configuration 200 is no longer grid tied and solar panel 100a is generating standalone output AC power 195a. Each of the solar panels 100b through 100n then receives input AC power via the standalone output AC power 195a internally generated by the master solar panel 100a. Solar panel 100b receives input AC power 195a from solar panel 100a and solar panel 100c receives the input AC power 195b from the solar panel 100b.

The solar panel configuration 200 may automatically transition the master/slave designations between each of the solar panels 100a through 100n without user intervention. As noted above, any solar panel 100a through 100n may be designated as the master of the solar panel configuration 200 when it no longer receives input AC power. And the master solar panel will automatically transition to a slave when it senses input AC power coming into it. At that point, the master solar panel automatically terminate its internal standalone output AC power generation from its own previously stored DC power That solar panel then automatically synchronizes to the power signal characteristics of the input AC power it now receives to parallel the output AC power provided by the new master solar panel and begin operating as a slave by generating output AC power it now receives.

For example, when solar panel 100b operates as a master, the solar panel 100b is not receiving input AC power but rather is internally generating its own standalone output AC power 195b from its own previously stored DC power. The solar panel 100b continues to operate as the master until the solar panel 100b senses that input AC power 195a is being received by it from the solar panel 100a, which is generating the input AC power 195a. The solar panel 100b then automatically terminates internally generating its own standalone output AC power 195b from its own previously stored DC power, and automatically synchronizes the standalone output AC power 195b to the frequency, phase, amplitude, and current of the input AC power 195a. In other words the solar panel 100b transitions to being a slave when the solar panel 100b generates the output AC power 195b from the input AC power 195a rather than from its own previously stored DC power.

The solar panel configuration 200 may also automatically transition the slave solar panels 100a through 100n to being a master without user intervention. As noted above, solar panels 100a through 100n may be designated as slaves when they are receiving input AC power. However, they may automatically transition to being a master when they no longer sense input AC power coming into them. At that point, they automatically begin internally generating their own standalone output AC power from their own previously stored DC power. The solar panels 100a through 100n may also have stored the power signal characteristics of the input power previously received by them and may automatically synchronize their own standalone output AC power to these characteristics. Again the solar panel 100a through 100b transitions from a slave to a master when they begin to internally generate their own standalone output AC power from their own previously stored DC power.

After the master-slave relationship is established between each of the master solar panels 100(a-n), the paralleled output AC power of the master solar panel configuration 200 may be maintained by the solar panel converter 100a and each of the slave solar panels 100(b-n). The master solar panel 100a may maintain the voltage of the paralleled output AC power while the slave solar panels 100(b-n) provide the current to maintain the voltage of the paralleled output AC power at a reference voltage.

However, the voltage of the paralleled output AC power may decrease when the external electronic device the individual requests to power, such as the hair dryer, is coupled to at least one of the outputs for the solar panels 100(a-n). Each of the slave solar panels 100(b-n) may increase the current of the paralleled output AC power so that the voltage of the paralleled output AC power maintained by the master solar panel 100a is increased back to the reference voltage sufficient to generate the paralleled output AC power. The reference voltage of the paralleled output AC power is the voltage level that is to be maintained to generate the paralleled output AC power that is sufficient to power the external electronic device. The reference voltage may be specified to be any voltage that is sufficient to maintain the paralleled output AC power that will be apparent to those skilled in the relevant art(s) without departing from the spirit and scope of the disclosure.

Each of the slave solar panels 100(b-n) may continue to generate current sufficient to maintain the voltage of the paralleled output AC power at the reference voltage so that the external electronic device is powered by the paralleled output AC power. However, eventually each of the slave solar panels 100(b-n) may have their DC sources depleted to the point where each of the slave solar panels 100(b-n) no longer have current that is sufficient to maintain the voltage of the paralleled output AC power at the reference voltage sufficient to generate the paralleled output AC power. At that point, the master solar panel 100a may begin to provide current to maintain the voltage of the paralleled output AC power at the reference voltage sufficient to generate the paralleled output AC power.

The solar panel configuration 200 may continue to generate output AC power even when a particular slave solar panel 100a through 100n may no longer be functional. In such cases, the dysfunctional slave solar panel 100a through 100n continues to pass through the standalone output AC power generated by the master solar panel 100a through 100n to each of the other slave solar panels 100a through 100n. For example, when the master solar panel 100a acts as the master and the solar panels 100b and 100n act as the slaves, if the slave solar panel 100b fails and is no longer functional, it will continue to pass through the output standalone AC power 195a generated by the master solar panel 100a to the functional slave solar panel 100n so that the other functional slave solar panel 100n may continue to generate output AC power 195n from the standalone output AC power 195a.

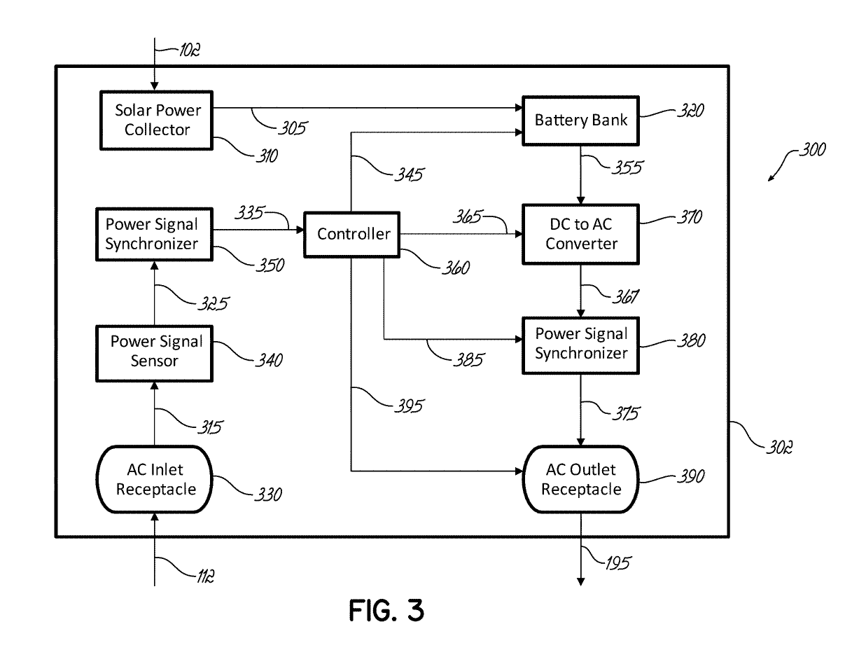

FIG. 3 is a block diagram of another exemplary solar panel 300 that may be used in the solar panel configuration 200 according to an exemplary embodiment of the present disclosure. Although FIG. 3 depicts a block diagram of the solar panel 300, FIG. 3 may also depict a block diagram of one of the plurality of solar panels 100a through 100n used in the solar panel configuration 200 depicted in FIG. 2 as well as the single solar panel 100 depicted in FIG. 1_Solar panel 300 will also automatically transition to internally generating standalone output AC power 195 based on the stored DC power 355 provided by the battery bank 320 when the power signal sensor 340 no longer senses the received input AC power 315. The solar panel 300 will also automatically transition to operating as a master when the power signal sensor 340 no longer senses the received input AC power 315. Solar panel 300 will also automatically transition to operating as a slave when the power signal sensor 340 begins to sense the received input AC power 315.

Enclosed within a single housing 302 for solar panel 300 is a solar power collector 310, a battery bank 320, an AC inlet receptacle 330, a power signal sensor 340, a power signal synchronizer 350, a controller 360, a DC to AC converter 370, a power signal synchronizer 380, and an AC outlet receptacle 390.

The solar panel collector 310 captures the solar or other light energy 102 from a solar or light source, e.g., the sun. The solar panel collector 310 may include a single and/or multiple photovoltaic (“PV”) solar panels or arrays that convert the solar energy 102 into the captured DC power 305. The solar panel collector 310 captures solar energy 102 when the solar source is available and is radiating solar energy 102 in a sufficient manner for the solar panel collector 310 to capture. The solar panel collector 310 converts the solar energy 102 into DC captured power 305 in a wide range of voltages and/or current capacities. The solar panel collector 310 may include photovoltaic solar panels categorized as, but not limited to, mono-crystalline silicon, poly-crystalline silicon, amorphous silicon, cadmium telluride, copper indium selenide, thin-film layers, organic dyes, organic polymers, nanocrystals and/or any other type of photovoltaic solar panels that will be apparent to those skilled in the relevant art(s) without departing from the spirit and scope of the disclosure. The solar panel collector 310 may also be any shape or size that is sufficient to capture the solar energy 102 that will be apparent to those skilled in the relevant art(s) without departing from the spirit and scope of the disclosure.

The battery bank 320 receives and stores the captured DC power 305. The battery bank 320 accumulates the captured DC power 305 as the captured DC power 305 is generated. The battery bank 320 may accumulate the captured DC power 305 until the battery bank 320 is at capacity and can no longer store any more of the captured DC power 305. The battery bank 320 may also store the AC input power 112 that is converted to the captured DC power 305 when the AC output receptacle 390 is not generating the output AC power 195. The battery bank 320 stores the captured DC power 305 until requested to provide the stored DC power 355. The stored DC power 355 provided by the battery bank 320 may include low-voltage but high energy DC power. The battery bank 320 may include one or more lithium ion phosphate (LiFePO₄) and/or one or more lead acid cells. However, this example is not limiting, those skilled in the relevant art(s) may implement the battery bank 320 using other battery chemistries without departing from the scope and spirit of the present disclosure. One or more cells of the battery bank 320 convert chemical energy into electrical energy via an electromechanical reaction.

As noted above, the solar panel 300 may automatically transition between the master and/or slave designations without user intervention. The solar panel 300 will operate as a slave when the AC inlet receptacle 330 is receiving AC input power 112, such as, AC power that is generated by the grid. The AC inlet receptacle 330 may also receive input AC power 112 when the AC inlet receptacle 330 is grid tied, such as AC power generated by a second solar panel when two panels are coupled together. The input AC power 112 may also be AC power generated by an AC power generator, an AC power inverter, or any other type of AC power source independent from the solar panel 300 that will be apparent to those skilled in the relevant art(s) without departing from the spirit and scope of the disclosure.

The AC inlet receptacle 330 may be in the form of a male configuration or a female configuration. A male AC inlet receptacle 330 prevents an individual from mistakenly plugging an electronic device into it with the intent to power the electronic device, as electronic devices typically have male plugs. The AC inlet receptacle 330 may also be fused protected. The AC inlet receptacle 330 may also be configured to receive the input AC power 112 in American, European, and/or any other power format that will be apparent to those skilled in the relevant art(s) without departing from the spirit and scope of the disclosure. The AC inlet receptacle 330 may further include an Edison plug, any of the several International Electrotechnical Commission (“IEC”) plugs, or any other type of plug that will be apparent to those skilled in the relevant art(s) without departing from the spirit and scope of the disclosure.

The AC inlet receptacle 330 provides received input AC power 315 to a power signal sensor 340. The power signal sensor 340 senses whether the solar panel 300 is receiving input AC power 112 through the AC inlet receptacle 330 based on whether it receives input AC power 315 from the AC inlet receptacle 330. Once the power signal sensor 340 senses the received input AC power 315, the power signal sensor 340 generates an incoming AC power signal 325. The incoming AC power signal 325 provides information regarding power signal characteristics of the input AC power 112 that the solar panel 300 is receiving through the AC inlet receptacle 330. These power signal characteristics may include, but are not limited to, frequency, phase, amplitude, current, voltage, and other like characteristics of power signals that will be apparent to those skilled in the relevant art(s) without departing from the spirit and scope of the disclosure.

The power signal sensor 340 provides the incoming AC power signal 325 to a power signal synchronizer 350. The power signal synchronizer 350 determines the power signal characteristics of the input AC power 112 that are provided by the incoming AC power signal 325. For example, the power signal synchronizer 350 determines the frequency, phase, amplitude, voltage, and current of the input AC power 112. The power signal synchronizer 350 generates a synchronized input power signal 335 that provides the power signal characteristics of the input AC power 112 to a controller 360.

The power signal synchronizer 350 also synchronizes the converted AC power 367 that is generated by the DC to AC converter 370 with the power signal characteristics of the input AC power 112. The power signal synchronizer 350 determines whether the power signal characteristics of the input AC power 112 are within the threshold of the power signal characteristics of the converted AC power 367. The power signal synchronizer 350 synchronizes the input AC power 112 with the converted AC power 367 when the power signal characteristics of the input AC power 112 are within the threshold of the power signal characteristics of the converted AC power 367. The power signal synchronizer 350 refrains from synchronizing the input AC power 112 with the converted AC power 367 when the power signal characteristics of input AC power 112 are outside the threshold of the power signal characteristics of the converted AC power 367.

For example, the power signal synchronizer 350 determines whether the frequency and the voltage of the sinusoidal waveform included in the input AC power 112 are within a threshold of 10% from the frequency and the voltage of the sinusoidal waveform included in the converted AC power 367. The power signal synchronizer 350 synchronizes the input AC power 112 with the converted AC power 367 when the frequency and the voltage of the input AC power 112 are within the threshold of 10% from the frequency and the voltage of the converted AC power 367. The power signal synchronizer 350 refrains from synchronizing the input AC power 112 with the converted AC power 367 when the frequency and the voltage of the input AC power 112 are outside the threshold of 10% from the frequency and the voltage of the converted AC power 367.

The output AC power 195 includes the input AC power 112 in parallel with the converted AC power 367 when the converted AC power 367 is synchronized with the input AC power 112. For example, the power signal synchronizer 350 synchronizes the converted AC power 367 to operate at within the threshold of 10% from the frequency and voltage of the input AC power 112. In one embodiment, the input AC power 112 embodies a substantially pure sinusoidal waveform. The substantially pure sinusoidal waveform may represent an analog audio waveform which is substantially smooth and curved rather than a digital audio waveform that includes squared off edges. In such an embodiment, the power signal synchronizer 350 synchronizes the converted AC power 367 to be within a threshold of the pure sinusoidal waveform embodied by the input AC power 112. After the power signal synchronizer 350 synchronizes the converted AC power 367 to the power signal characteristics of the input AC power 112, the power signal synchronizer 350 notifies the controller 360 of the synchronization via the synchronized input power signal 335.

The controller 360 receives the synchronized input power signal 335. The controller 360 determines the power signal characteristics of the input AC power 112 and then stores the power signal characteristics in a memory included in the controller 360. For example, the controller 360 stores the frequency, phase, amplitude, voltage, and/or current of the input AC power 112. After receiving the synchronized input power signal 335, the controller 360 is aware that the input AC power 112 is coupled to the AC inlet receptacle 330. In response to the input AC power 112 coupled to the AC inlet receptacle 330, the controller 360 stops generating a reference clock for the solar panel 300.

Also, in response to the input AC power 112 coupled to the AC inlet receptacle 330, the controller 360 also generates a battery bank signal 345. The controller 360 instructs the battery bank 320 via the battery bank signal 345 to no longer provide stored DC power 355 to the DC to AC inverter 370. The instruction by the controller 360 to the battery bank 320 to no longer provide stored DC power 355 to the DC to AC inverter 370 also terminates the standalone output AC power 195 that is generated from the stored DC power 355.

Further, in response to the input AC power 112 coupled to the AC inlet receptacle 330, the controller 360 confirms that the power signal synchronizer 350 has synchronized the converted AC power 367 to the power signal characteristics of the input AC power 112. After confirming that the power signal synchronizer 350 has synchronized the converted AC power 367 to the power signal characteristics of the input AC power 112, the controller 360 links in parallel the input AC power 112 being received by the AC inlet receptacle 330 with the converted AC power 367 to the AC outlet receptacle 390 to generate parallel AC power 395. The AC outlet receptacle 390 then outputs the output AC power 195 that includes the input AC power 112 in parallel with the converted AC power 367 with power signal characteristics that are substantially equivalent to the power signal characteristics of the input AC power 112. For example, the frequency, phase, amplitude, voltage, and/or current of the output AC power 195 may be substantially equivalent to the frequency, phase, amplitude, voltage, and/or current of the input AC power 112.

The AC outlet receptacle 390 may be in the form of a male or a female configuration. A female AC outlet receptacle 390 allows an individual to directly plug an electronic device into it as electronic devices typically have male plugs.

The AC outlet receptacle 390 may also be fused protected. The AC outlet receptacle 390 may be configured to provide the output AC power 195 in American, European, or any other power format that will be apparent to those skilled in the relevant art(s) without departing from the spirit and scope of the disclosure. The AC outlet receptacle 390 may also include an Edison plug, any of the IEC plugs, or any other type of plug that will be apparent to those skilled in the relevant art(s) without departing from the spirit and scope of the disclosure.

As noted above, the solar panel 300 will automatically transition between the master and/or slave designations without user intervention. The solar panel 300 will automatically transition from operating as a slave to operating as a master when the AC input power signal 112 diminishes and is no longer received by the AC inlet receptacle 330 such that the controller 360 no longer receives the synchronized input power signal 335. At that point, the controller 360 generates the battery bank signal 345 to instruct the battery bank 320 to begin generating stored DC power 355. The controller 360 generates a power conversion signal 365 to instruct the DC to AC converter 370 to convert the stored DC power 355 to converted AC power 367. The converted AC power 367 is high-voltage AC output power. The DC to AC converter 370 may use high frequency modulation in converting the stored DC power 355 to the converted AC power 367.

The controller 360 then provides a synchronized output power signal 385 to the power signal synchronizer 380. The synchronized output power signal 385 provides the power signal characteristics of the input AC power 112 when the input power signal 112 is coupled to the AC inlet receptacle 330 to the power signal synchronizer 380. For example, the synchronized output power signal 385 provides the frequency, phase, amplitude, voltage, and current of the input power signal 112 to the power signal synchronizer 380. The synchronized output power signal 385 also provides the reference clock to the power signal synchronizer 380.

The power signal synchronizer 380 then generates synchronized output AC power 375 by synchronizing the converted AC power 367 to the power signal characteristics of the input AC power 112 and the reference clock provided by the synchronized output power signal 385. In one embodiment, the input AC power 112 embodies a substantially pure sinusoidal waveform. In such an embodiment, the power signal synchronizer 380 synchronizes the converted AC power 367 to be within the threshold of the pure sinusoidal waveform embodied by the input AC power 112. The synchronized output AC power 375 includes power signal characteristics that are within the threshold of the power signal characteristics of the input AC power 112. For example, the synchronized output AC power 375 includes a frequency and voltage that is within the threshold of the frequency and voltage of the input AC power 112. The AC outlet receptacle 390 then generates the output AC power 195 based on the synchronized output power 375. Thus, the power converter 300 generates the output AC power 195 that is substantially similar to the input AC power 112 despite not receiving the input AC power 112 from other sources.

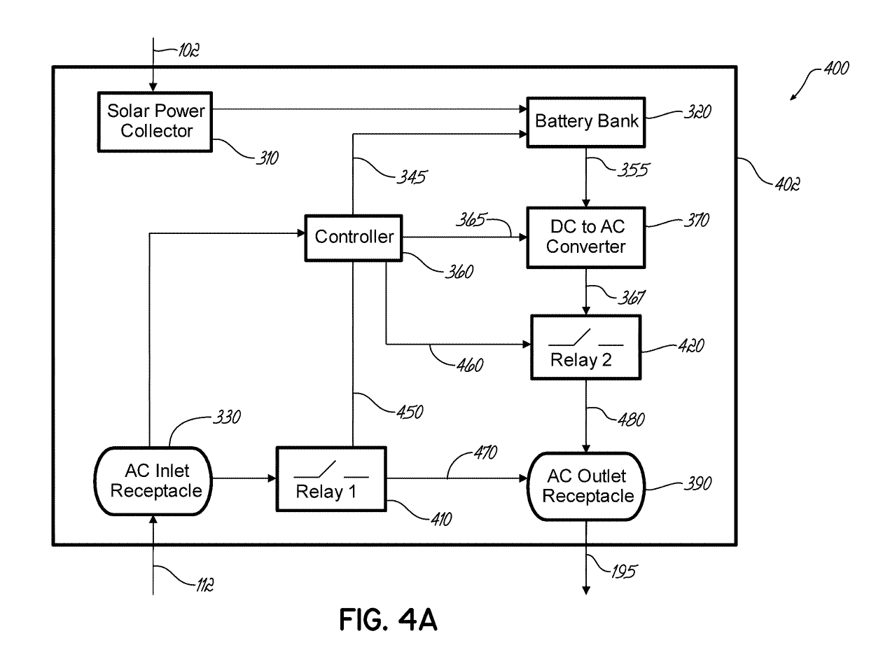

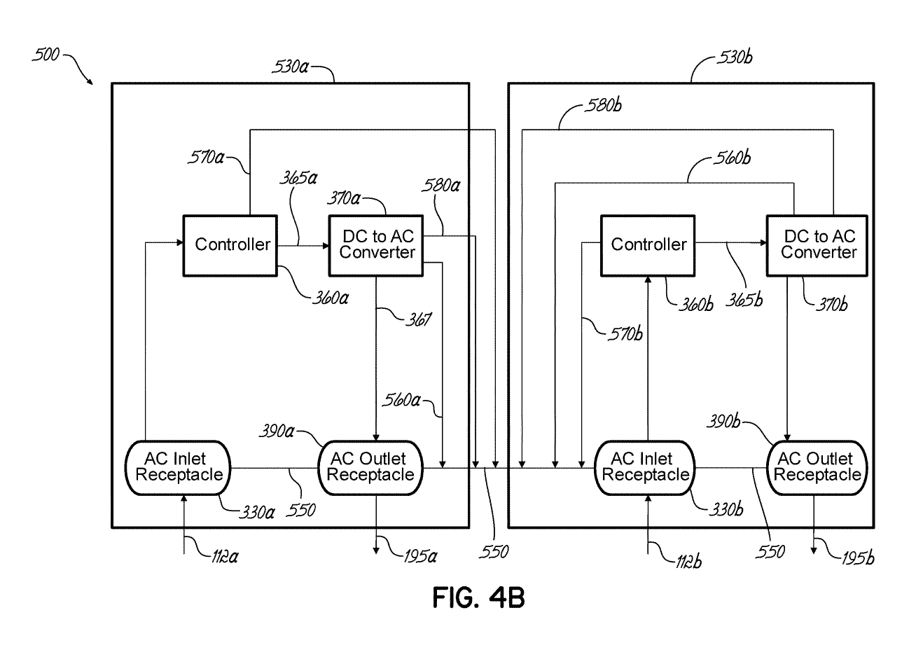

FIG. 4A is a block diagram of another exemplary solar panel 400 that may be used in the solar panel configuration 200 according to an exemplary embodiment of the present disclosure. Although, FIG. 4A depicts a block diagram of the solar panel 400, FIG. 4A may also depict a block diagram of one of the plurality of panels 100a through 100n used in the solar panel configuration 200 depicted in FIG. 2 and also the single solar panel 100 depicted in FIG. 1. The features depicted in the block diagram of the solar panel 300 may also be included in the solar panel 400 but have been omitted for simplicity.

The solar panel 400 may automatically transition from operating as a master and operating as a slave without user intervention based on a relay configuration. The solar panel 400 may be implemented using the solar power collector 310, the battery bank 320, the AC inlet receptacle 330, the controller 360, the DC to AC converter 370, the AC outlet receptacle 390, a first relay 410 and a second relay 420 each of which are enclosed within a housing 402 for the solar panel 400.

As noted above, the solar panel 400 operates as a slave when the controller 360 senses that the input AC power 112 is coupled to the AC inlet receptacle 330. The controller then terminates the generation of the standalone output AC power 195. The solar panel 400 operates as a master when the controller 360 no longer senses that the input AC power 112 is coupled to the AC inlet receptacle 330. The controller 360 then instructs the battery bank 320 and the DC to AC inverter 370 to begin generating the standalone output AC power 195. The relay configuration that includes a first relay 410 and a second relay 420 transitions the solar panel 400 between the master and slave modes based on the logic provided in Table 1.

TABLE 1

| | | |
|---|---|---|
| Master Mode | Relay 1 Open | Relay 2 Closed |
| Slave Mode | Relay 1 Closed | Relay 2 Closed |
| Unit Power Off | Relay 1 Closed | Relay 2 Open |
| (Bypassed) | | |

When automatically transitioning from the slave mode to the master mode, the controller 360 no longer senses the input AC power 112 coupled to the AC inlet receptacle 330. At this point, the controller 360 generates a first relay signal 450 that instructs the first relay 410 transition to the open state (logic 0). The controller 360 also generates a second relay signal 460 that instructs the second relay 420 to transition to the closed state (logic 1). The controller 360 also generates battery bank signal 345 that instructs the battery bank 320 to begin providing the stored DC power 355 to the DC to AC converter 370 to generate the converted AC power 367. Because the second relay 420 is in the closed position (logic 1), the converted AC power 367 passes through the second relay 420, and as shown by arrow 480, onto the AC outlet receptacle 390 so that the solar panel 400 provides the AC output power 195 generated from the stored DC power 355 rather than the input AC power 112. The open state (logic 0) of the first relay 410 prevents any remaining input AC power 112 from reaching the AC output receptacle 390 when the solar panel 400 is generating the standalone AC output power 195 as operating as the master.

Once the controller 360 senses the input AC power 112 coupled to the AC inlet receptacle 330, the controller 360 automatically generates the power conversion signal 365 to instruct the DC to AC converter 370 to no longer provide converted AC power 367 so that the solar panel 400 no longer generates the standalone AC output power 195. The controller 360 also automatically generates the second relay signal 460 to instruct the second relay 420 to transition to the open state (logic 0). The controller 360 also generates the first relay signal 450 to instruct the first relay 410 to transition to the closed state (logic 1). After the second relay 420 transitions to the open state (logic 0) and the first relay 410 transitions to the closed state (logic 1), any input AC power 112 coupled to the AC inlet receptacle 330 passes through the first relay 410, and as shown by arrow 470, onto the AC outlet receptacle 390 so that the solar panel 400 generates the output AC power 195.

The second relay 420 remains in the open state (logic 0), until the controller 360 has successfully synchronized the solar panel 400 to the input AC power 112 coupled to the AC inlet receptacle 330. After the controller 360 properly synchronizes solar panel 400 to the input AC power the controller 360 then generates the second relay signal 460 to instruct the second relay 420 to transition from the open state (logic 0) to the closed state (logic 1). After the second relay 420 transitions from the open state (logic 0) to the closed state (logic 1), the solar panel 400 will generate output AC power 195 that includes the converted AC power 367 that is in parallel to the input AC power 112.

The solar panel 400 also operates in a bypass mode. In the bypass mode, the solar panel 400 is powered off and is no longer functioning. In embodiment, the controller 360 generates the first relay signal 450 and instructs the first relay 410 to transition into the closed state (logic 1). The controller 360 also generates the second relay signal 460 and instructs the second relay 420 to transition into the open state (logic 0). In another embodiment, the first relay 410 and the second relay 420 are spring loaded relay switches. When the solar panel 400 powers off, the electromagnetic coil of the first relay 410 is no longer energized so the spring pulls the contacts in the first relay 410 into the up position. The closing of the first relay 410 and the opening of the second relay 420 causes the solar panel 400 to be a pass through where the input AC power 112 passes through the solar panel 400 and onto a second solar panel daisy chained to the solar panel 400 and/or to an electronic device being powered by the input AC power 112. Thus, additional solar panels and/or electronic devices down the line from the dysfunctional solar panel 400 continue to operate off of the input AC power 112. The first relay 410 and the second relay 420 may be implemented in hardware, firmware, software, or any combination thereof that will be apparent to those skilled in the relevant art(s) without departing from the spirit and scope of the disclosure.

FIG. 4B is a block diagram of another exemplary solar panel configuration 500 according to an exemplary embodiment of the present disclosure. Although, FIG. 4B depicts a block diagram of the solar panel configuration 500, FIG. 4B may also depict a block diagram of the plurality of solar panels 100(a-n) used in the solar panel configuration 200 depicted in FIG. 2.

The solar panel configuration 500 may be implemented using the master solar panel 530a and the slave solar panel 530b. The master solar panel 530a includes a master AC inlet receptacle 330a, a master AC outlet receptacle 390a, a master controller 360a, and a master DC to AC converter 370a. The slave solar panel 530b includes a slave AC inlet receptacle 330b, a slave AC outlet receptacle 390b, a slave controller 360b, and a slave DC to AC converter 370b. The master solar panel 530a and the slave solar panel 530b are coupled together by the AC bus 550. The master solar panel 530a and the slave solar panel 530b share many similar features with the solar panel 100, the plurality of solar panels 100(a-n), the solar panel 300, and the solar panel 400; therefore, only the differences between the solar panel configuration 500 and the solar panel 100, the plurality of solar panels 100(a-n), the solar panel 300, and the solar panel 400 will be discussed in further detail.

As mentioned, the solar panel 530a operates as the master and the solar panel 530b operates as the slave. However, as discussed in detail above, the solar panel 530a and 530b may operate as either the master or slave depending on whether input AC power is applied to the respective AC inlet receptacle of each. The master solar panel 530a may apply a constant voltage to an AC bus 550 that is coupling the AC inlet receptacle 330a and the AC outlet receptacle 390a of the master solar panel 530a to the AC inlet receptacle 330b and the AC outlet receptacle 390b of the slave solar panel 530b to maintain the paralleled output AC power generated by the solar panel configuration 500. The slave solar panel 530b may increase the current applied to the AC bus 550 when the voltage of the AC bus 550 decreases below the reference voltage due to an external electronic device being coupled to the solar panel configuration 500. The slave solar panel 530b may increase the current applied to the AC bus 550 so that the voltage of the AC bus 550 is increased back to the reference voltage so that the paralleled output AC power is maintained to adequately power the external electronic device.

After the master solar panel 530a has synchronized with the slave solar panel 530b, the external input AC power 112a is in parallel with the output AC power 195a and the output AC power 195b generating the paralleled output AC power. The paralleled output AC power may be accessed by coupling the external electronic device to the master AC outlet receptacle 390a and/or the slave AC outlet receptacle 390b. The AC bus 550 may provide an access point to the paralleled output AC power for the master controller 360a and the slave controller 360b to monitor.

The master controller 360a may initially instruct the master DC to AC converter 370a with a master power conversion signal 365a to provide a constant master voltage 560a to the AC bus 550 to maintain the paralleled output AC power at a specified level. The specified level may be the maximum output AC power that may be generated by the power converter configuration 500 with the external input AC power 112a in parallel with the output AC power 195a and the output AC power 195b. However, the specified level may be lowered based on the constant master voltage 560a supplied by the master DC to AC converter 370a to the AC bus 550. The specified level may be associated with the reference voltage of the paralleled output AC power. As noted above, the reference voltage of the paralleled output AC power is the voltage level that is to be maintained to generate the paralleled output AC power that is sufficient to power the external electronic device.

After an external electronic device is coupled to the master AC outlet receptacle 390a and/or the slave AC outlet receptacle 390b, the paralleled output AC power may temporarily decrease due to the load applied to the AC bus 550 by the external electronic device. The slave controller 360b may monitor the AC bus 550 with a slave AC bus monitoring signal 570b to monitor the voltage of the AC bus 550 to determine whether the voltage has decreased below the reference voltage of the AC bus 550 which in turn indicates that the paralleled output AC power has decreased below the specified level. The slave controller 360b may then instruct the slave DC to AC converter 370b with a slave power conversion signal 365b to increase the slave current 580b that is provided to the AC bus 550 when the slave controller 360b determines that the voltage of the AC bus 550 decreases after the external electronic device is coupled to the master AC outlet receptacle 390a and/or the slave AC outlet receptacle 390b. The slave current 580b may be increased to a level sufficient to increase the voltage of the AC bus 550 back to the reference voltage. Increasing the voltage of the AC bus 550 back to the reference voltage also increases the paralleled output AC power so that the paralleled output AC power is reinstated to the specified level with a minimal lapse in time. The maintaining of the paralleled output AC power at the specified level prevents a delay in the powering of the external electronic device.

The slave controller 360b may continue to monitor voltage of the AC bus 550 with the slave AC bus monitoring signal 570b to ensure that the voltage of the AC bus 550 does not decrease below the reference voltage. The slave controller 360b may continue to instruct the slave DC to AC converter 370b with the slave power conversion signal 365b to increase or decrease the slave current 580b accordingly based on the voltage of the AC bus 550 to maintain the paralleled output AC power at the specified level.

The slave DC to AC converter 370b may continue to provide the slave current 580b to the AC bus 550 until the slave DC to AC converter 370b no longer has the capability to provide the slave current 580b at the level necessary to maintain the voltage of the AC bus 550 at the reference voltage. For example, the slave DC to AC converter 370b may continue to provide the slave current 580b to the AC bus 550 until the DC source of the slave power converter 530b is drained to the point where the slave DC to AC converter 370b can no longer provide the slave current 580b at the level sufficient to maintain the voltage of the AC bus 550 at the reference voltage.

The master controller 360a also monitors the AC bus 550 with a master AC bus monitoring signal 570a. The master controller 360b monitors the AC bus 550 to determine when the voltage of the AC bus 550 decreases below the reference voltage for a period of time and is not increased back to the reference voltage At that point, the master controller 360a may recognize that the slave DC to AC converter 370b is no longer generating slave current 580b at the level sufficient to maintain the voltage of the AC bus 550 at the reference voltage. The master controller 360a may then instruct the master DC to AC converter 370a with the master power conversion signal 365a to increase the master current 580a to a level sufficient to increase the voltage of the AC bus 550 back to the reference voltage so that the paralleled output AC power may be maintained at the specified level. As a result, a delay in the powering of the external electronic device may be minimized despite the draining of the DC source of the slave power converter 530b.

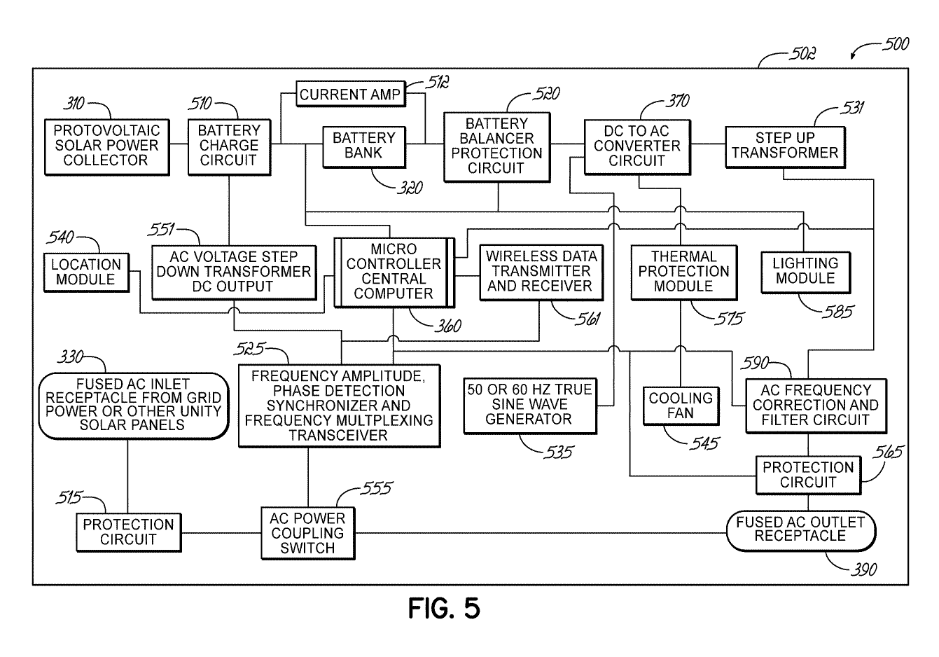

FIG. 5 is a block diagram of another exemplary solar panel 505 that may be used in the solar panel configuration 200 according to an exemplary embodiment of the present disclosure. Although, FIG. 5 depicts a block diagram of the solar panel 505, one of ordinary skill in the art will recognize that FIG. 5 may also depict a block diagram of one of the plurality of panels 100a through 100n used in the solar panel configuration 200 depicted in FIG. 2 as well as the solar panel 100 depicted in FIG. 1. The features depicted in the block diagram of the solar panel 300 and 400 may also be included in the solar panel 505 but have been omitted for simplicity.

The solar panel 505 may be implemented using the solar power collector 310, a battery charge circuit 510, a current amplifier 512, the battery bank 320, a battery balancer protection circuit 520, a step up transformer 531, a location module 540, an AC voltage step down transformer DC output 551, a wireless data transmitter and receiver 561, a thermal protection module 575, an integrated light source module 585, an AC frequency correction and filter circuit 590, a protection circuit 515, a fused AC inlet receptacle from grid power or other unity solar panels 330, a micro controller central computer 360, the DC to AC converter circuit 370, a frequency, amplitude, phase detection synchronizer and frequency multiplexing transceiver 525, a 50 or 60 Hertz (“Hz”) true sine wave generator 535, a cooling fan 545, a protection circuit 565, an AC power coupling switch 555, and a fused AC outlet receptacle 390, each of which are enclosed within a housing for the solar panel 505.

The battery charge circuit 510 may include passive and/or active circuitry as well as integrated circuits to control and/or regulate the charging of the battery bank 320 included within the solar panel 505. The battery charge circuit 510 may have bidirectional communication with a computing device, such as controller 360. The controller 360 may also control the battery charge circuit 510. The current amplifier 512 may increase the output current of the solar panel and assist in charging the battery bank 320.

The battery balancer protection circuit 520 is disposed within the housing 502 of the solar panel 505. The battery balancer protection circuit 520 may include passive and/or active circuitry as well as integrated circuits that may be controlled by the controller 360. The battery balancer protection circuit 520 may be used to ensure safe discharge and recharge of the individual cells within the battery bank 320.

The solar panel 505 may further include a location module 540. The location module 540 may include one or several location sensors such as but not limited to a global positioning system (“GPS”), a compass, a gyroscope, an altitude, and/or any other location sensor digital media file that will be apparent to those skilled in the relevant art(s) without departing from the spirit and scope of the disclosure. The location module 540 may be used to send data to the controller 360 through the wireless data transmitter and receiver 561 to an external personal computing device.

The AC voltage step down transformer 551 is included in the solar panel 505. The step down transformer 551 may be used to charge the battery bank 320 from the AC inlet receptacle 330 through the battery charge circuit 510. The step down transformer 551 may include iron, steel, ferrite, or any other materials and fashioned specifically to satisfy power requirements for charging the battery bank 320. The step down transformer 551 may also have a filtered DC output.

As discussed above, the solar panel 505 includes a computing device such as the controller 360. The controller 360 may be used to control and/or monitor the solar panel 505. The controller 360 may be a single or multiple processor based and may be able to receive software and/or firmware updates wirelessly through the associated wireless data transmitter and receiver 561 or through a hardware connection such as the frequency multiplexing transceiver 525. The controller 360 may be connected to any part of the solar panel 505 for central control, remote control, general monitoring, and/or data collection purposes. The wireless data transmitter and receiver 561 may use Bluetooth, Wi-Fi, cellular, and/or any other acceptable radio frequency data transmissions and reception techniques that will be apparent to those skilled in the relevant art(s) without departing from the spirit and scope of the disclosure. The transmitter and receiver 561 may be used to transmit data from the solar panel 505 to one or more external personal computing devices.

The solar panel 505 includes a thermal protection module 575. The thermal protection module 575 includes one or more sensors positioned in one or more locations throughout any part of the solar panel 505 for the purpose of temperature monitoring. The thermal protection module 575 is connected to the controller 360 and may be used to transmit data from the solar panel 505 to external personal computing devices.

As shown, the solar panel 505 may include the integrated light source 585. The integrated light source 585 may include one or more integrated lights inside or disposed on an exterior surface of the housing of the solar panel 505 and may be used as a light source. The integrated lights may vary in color, intensity, color temperature size, frequency, and/or brightness. The integrated light source 585 may be coupled to the controller 360. The integrated light source 585 may be used to transmit data from the solar panel 505 to external personal computing devices.

The solar panel 505 further includes a grid frequency, amplitude, power phase detection synchronizer and frequency multiplexing transceiver 525, which may synchronize multiple AC power sources and transmit data between one or more solar panels 505 via a standard AC power line.

The solar panel 505 further includes a frequency generator, such as a 50 Hz or 60 Hz true sine wave generator 535. The frequency generator may also be other types of generators configured to output a signal at a particular reference frequency. The sine wave generator 535 may provide a sine wave reference to the DC to AC converter 370. The sine wave generator 535 may be coupled to the controller 360 as well as the grid frequency, amplitude, power phase detection synchronizer and frequency multiplexing transceiver 525. Moreover, the sine wave generator 535 may include analog and/or digital circuitry.

The solar panel 505 may further include a cooling fan 545 disposed within the housing of the solar panel 505. The cooling fan 545 may include one or more cooling fans arranged in a way that best ventilates an interior at least partially formed by the housing of the solar panel 505 in which one or more components are disposed. The cooling fan 545 may be coupled to the thermal protection module 575 and/or the controller 360.

Furthermore, the solar panel 505 includes an AC frequency correction and filter circuit 590. The frequency correction and filter circuit 590 may be controlled by the controller 360 through the 50 Hz or 60 Hz true sine wave generator 535. In addition, the frequency correction and filter circuit 590 may receive AC power from the step up transformer 531 and may output corrected and filtered AC power to a protection circuit 515 of the solar panel 505. The protection circuit 515 provides surge and fuse protection and may be controlled and monitored by the controller 360.

Moreover, the solar panel 505 has an AC coupling switch 555 that is configured to couple the AC power from the AC inlet receptacle 330 with AC grid equivalent power generated by the solar panel 505 such that synchronized AC power from the AC inlet receptacle 330 and the solar panel 505 are coupled together for output from the AC outlet receptacle 390. The AC coupling switch 555 may be controlled by the controller 360 in conjunction with the grid frequency, amplitude, power phase detection synchronizer and frequency multiplexing transceiver 525.

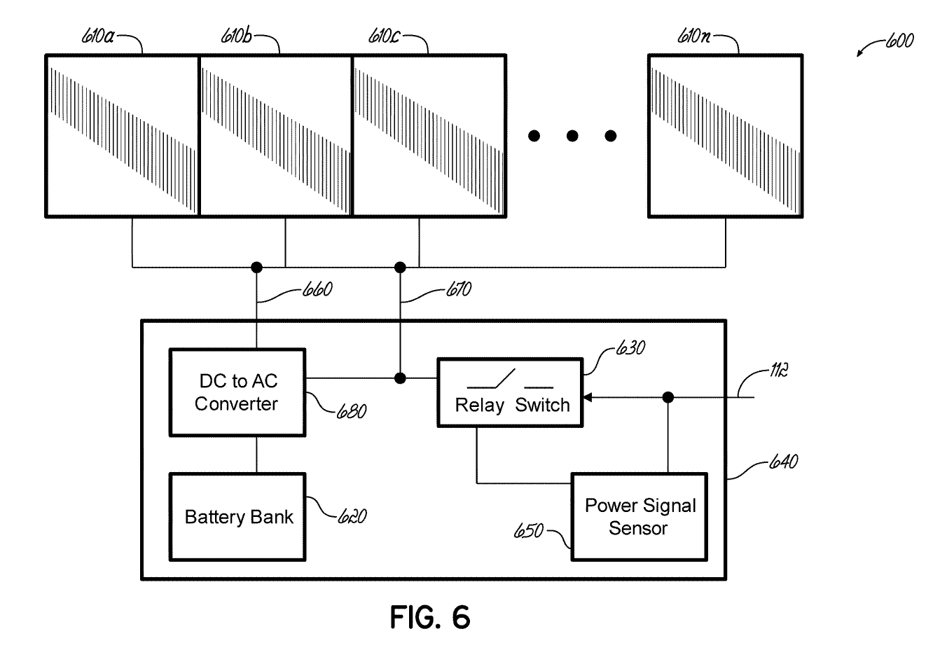

FIG. 6 illustrates a block diagram of another exemplary solar panel configuration according to an exemplary embodiment of the present disclosure. The solar panel configuration 600 includes a plurality of solar panels 610a through 610n that may be daisy chained together and coupled to a grid-tie system 640 to form the solar panel configuration 600, where n is an integer greater than or equal to one. The grid-tie system 640 monitors the input AC power 112 that is generated by the grid to determine whether the power grid remains stable to generate the input AC power 112. The grid-tie system 640 instructs the battery bank 620 to provide converted AC power 660 to the plurality of solar panels 610a through 610n when the grid tie system 640 determines that the power grid has failed. Thus, the grid-tie system 640 provides back up power to the plurality of solar panels 610a through 610n when the grid fails.

The grid-tie system 640 includes the battery bank 620, a relay switch 630, a DC to AC converter 680, and a power signal sensor 650. The solar panel configuration 600 shares many similar features with the solar panel 100, the plurality of solar panels 100a through 100n, the solar panel 300, the solar panel 400, the solar panel 500, and the solar panel configuration 200, and as such, only the differences between the solar panel configuration 600 and the solar panel 100, the plurality of solar panels 100a through 100n, the solar panel 300, the solar panel 400, the solar panel 500, and the solar panel configuration 200 are to be discussed in further detail.

The plurality of solar panels 610a through 610n may include larger solar panels with larger capacities to capture solar energy and convert the captured solar energy into DC power that may be stored in the battery bank 620. The grid-tie system 640 may automatically link the plurality of solar panels 610a through 610n to the input AC power 112 when the grid-tie system 640 is grid tied. The grid-tie system 640 may also automatically provide the converted AC power 660 to the plurality of solar panels 610a through 610n when the grid-tie system 640 is no longer grid tied such that the input AC power 112 is no longer available to the plurality of solar panels 610a through 610n.

Each of the plurality of solar panels 610a through 610n may be updated as to the status of the grid. For example, the plurality of solar panels 610a through 610n may be updated when the grid fails via a signal that is transmitted through the AC power line of the grid.

In another embodiment, the grid-tie system 640 may control the converted AC power 660 so that the DC power stored in the battery bank 620 is not depleted from the use of the converted AC power 660. For example, the grid-tie system 640 may dial back the use of the converted AC power 660 from maximum capacity to conserve the DC power stored in the battery bank 620.

The grid-tie system 640 includes a relay switch 630. The relay switch 630 transitions into an open state (logic 0) when the grid fails and is no longer providing the input AC power 112 to the grid-tie system 640 so that the grid-tie system 640 may be substantially disconnected from the grid. The grid-tie system 640 immediately instructs the DC to AC converter 680 to convert the DC power stored in the battery bank 620 to begin providing the converted AC power 660 to the plurality of solar panels 610a through 610n to replace the input AC power 112 no longer supplied to the grid-tie system 640. The converted AC power 660 may include power signal characteristics that have already been synchronized with the power signal characteristics included in the input AC power 112 before the grid went down. For example, the converted AC power 660 may include a frequency, phase, amplitude, voltage and/or current that is substantially similar to the frequency, phase, amplitude, voltage and/or current of the input AC power 112. As a result, the plurality of solar panels 610a through 610n fail to recognize that the grid has failed and is no longer providing the input AC power 112 to the grid tie system 640.

After the grid fails, the power signal sensor 650 continues to sense the power signal characteristics on the failed side of the relay switch 630. For example, the power signal sensor 650 continues to sense the voltage, current, frequency, and/or phase on the failed side of the relay switch 630. As the grid begins to come back up, the power signal sensor 650 recognizes that the power signal characteristics on the failed side of the relay switch 630 are beginning to show that the grid is coming back up. As the grid stabilizes, the grid tie system 640 begins to adjust the power signal characteristics of the converted AC power 660 to become substantially equivalent to the power signal characteristics of the input AC power 112 being sensed by the power signal sensor 650. For example, the grid tie system 640 synchronizes the converted AC power 660 so that the frequency, phase, amplitude, voltage, and current of the converted AC power 660 becomes substantially equivalent to the frequency, phase, amplitude, voltage, and current of the of the input AC power 112 being sensed by the power signal sensor 650.

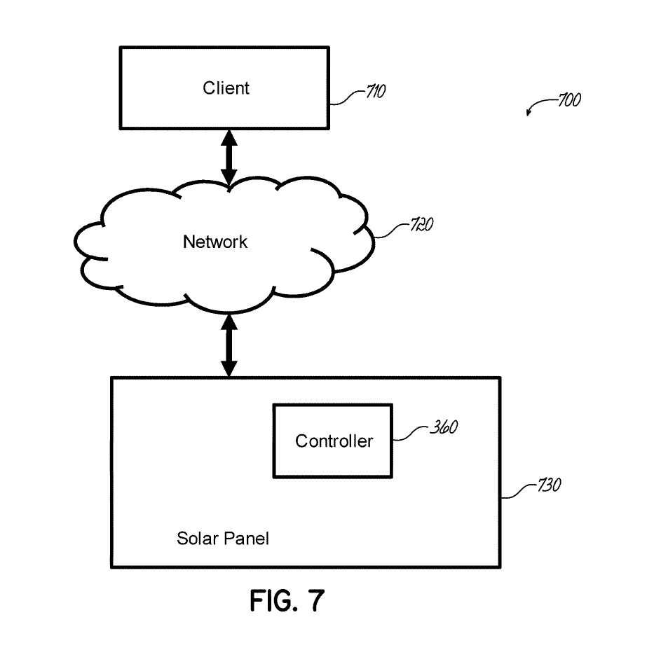

After the power signal characteristics of the converted AC power 660 are substantially equivalent to the power signal characteristics of the input AC power 112, the grid tie system 640 transitions the relay switch 630 into a closed position (logic 1). The plurality of solar panels 610a through 610n are then no longer running off of the converted AC power 660 but are rather running off of the input AC power 112 provided by the grid. FIG. 7 shows an illustration of a wireless solar panel configuration 700. The wireless solar panel configuration 700 includes a client 710, a network 720, and a solar panel 730.

One or more clients 710 may connect to one or more solar panels 730 via network 720. The client 710 may be a device that includes at least one processor, at least one memory, and at least one network interface. For example, the client may be implemented on a personal computer, a hand held computer, a personal digital assistant (“PDA”), a smart phone, a mobile telephone, a game console, a set-top box, and the like.

The client 710 may communicate with the solar panel 730 via network 720. Network 720 includes one or more networks, such as the Internet. In some embodiments of the present invention, network 720 may include one or more wide area networks (“WAN”) or local area networks (“LAN”). Network 720 may utilize one or more network technologies such as Ethernet, Fast Ethernet, Gigabit Ethernet, virtual private network (“VPN”), remote VPN access, a variant of IEEE 802.11 standard such as Wi-Fi, and the like. Communication over network 720 takes place using one or more network communication protocols including reliable streaming protocols such as transmission control protocol (“TCP”). These examples are illustrative and not intended to limit the present invention.

The solar panel 730 includes the controller 360. The controller 360 may be any type of processing (or computing) device as described above. For example, the controller 360 may be a workstation, mobile device, computer, and cluster of computers, set-top box, or other computing device. The multiple modules may also be implemented on the same computing device, which may include software, firmware, hardware, or a combination thereof. Software may include one or more application on an operating system. Hardware can include, but is not limited to, a processor, memory, and a graphical user interface (“GUI”) display.

The client 710 may communicate with the solar panel 730 via network 720 to instruct the solar panel 730 as to the appropriate actions to take based on the time of the day, weather conditions, travel arrangements, energy prices, etc. For example, the client 710 may communicate with the solar panel 730 to instruct solar panel 730 to charge its batteries via the input AC power provided by the grid during times of the day in when the sunlight is not acceptable. In another example, the client 710 may communicate with the solar panel 730 via network 720 to instruct the solar panel 730 to operate off of the DC power provided by the internal batteries included in the solar panel 730 during peak utility hours. In such an example, the client 710 may communicate with the solar panel 730 to charge its internal batteries from the solar energy captured by the solar panel 730 during off peak hours while the solar panel 730 relies on the input AC power provided by the grid. The client 710 may then communicate with the solar panel 730 to run off of its charged internal batteries during peak hours when the grid is stressed. In another embodiment, the client 710 may communicate with the solar panel 730 via network 720 to receive status updates of the solar panel 730.

The solar panel 730 may also include a GPS. The client 710 may communicate with the solar panel 730 via network 720 to analyze the GPS coordinates of the solar panel 730 and adjust the solar panel 730 so that the solar panel 730 may face the sun at an angle that maximizes the solar energy captured.

The solar panel 730 may also include a tilt mechanism that is built into its back that has a stepper motor that adjusts the angle of solar panel 730 to maximize its exposure to solar energy.

The client 710 may also remotely control the output AC power of the solar panel 730 via the network 720. Hence, the client 710 may dial back the output AC power of the solar panel 730 so that the DC power stored in the battery bank of the solar panel 730 is not depleted.

In one embodiment, the client 710 may obtain information regarding the solar panel 730 via the network 720 that may include but is not limited to energy produced by the solar panel 730, energy consumed by the solar panel 730, the tilt of the solar panel 730, the angle of the solar panel 730, the GPS coordinates of the solar panel 730, and any other information regarding the solar panel 730 that may be communicated to the client 710 via the network 720 that will be apparent to those skilled in the relevant art(s) without departing from the spirit and scope of the disclosure.

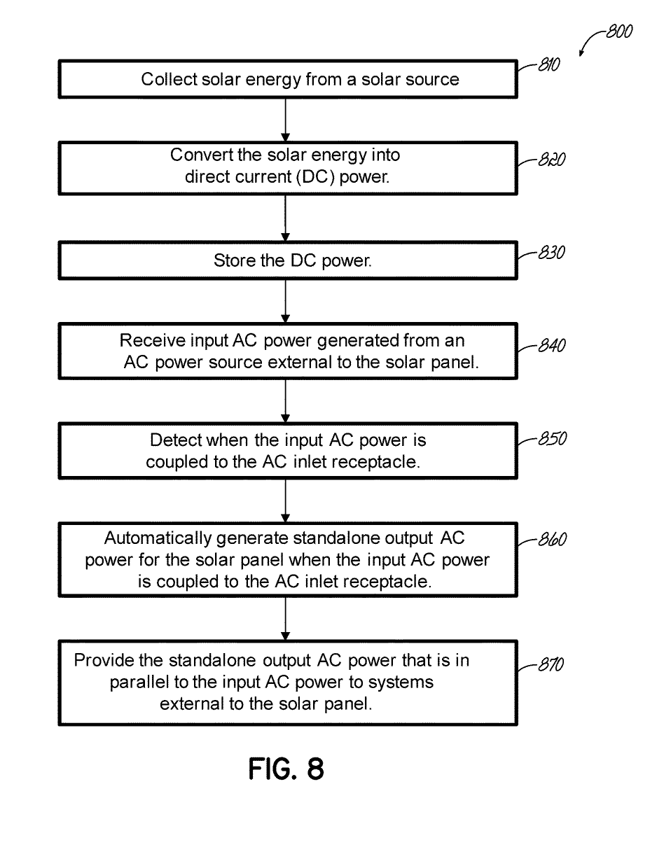

FIG. 8 is a flowchart of exemplary operational steps 800 of the solar panel according to an exemplary embodiment of the present disclosure. The present disclosure is not limited to this operational description. Rather, other operational control flows may also be within the scope and spirit of the present disclosure. The following discussion describes the steps in FIG. 8.

At step 810, the photovoltaic solar power collector 310 collects solar energy from a solar source.

At step 820, the collected solar energy is converted into captured DC power 305.

At step 830, the captured DC power 305 is stored in a battery bank 320.

At step 840, the AC inlet receptacle 330 receives input AC power 112 generated from an AC power source external to the solar panel, for example, by the electric utility grid.

At step 850, the power signal sensor 340 detects when the input AC power 112 is coupled to the AC inlet receptacle 330.

At step 860, if the power signal sensor 340 detects input AC power 112, then standalone output AC power 195 for the solar panel that is in parallel to the input AC power 112 is automatically generated.

At step 870, the standalone output AC power 195 that is in parallel to the input AC power 112 is provided to systems external to the solar panel.

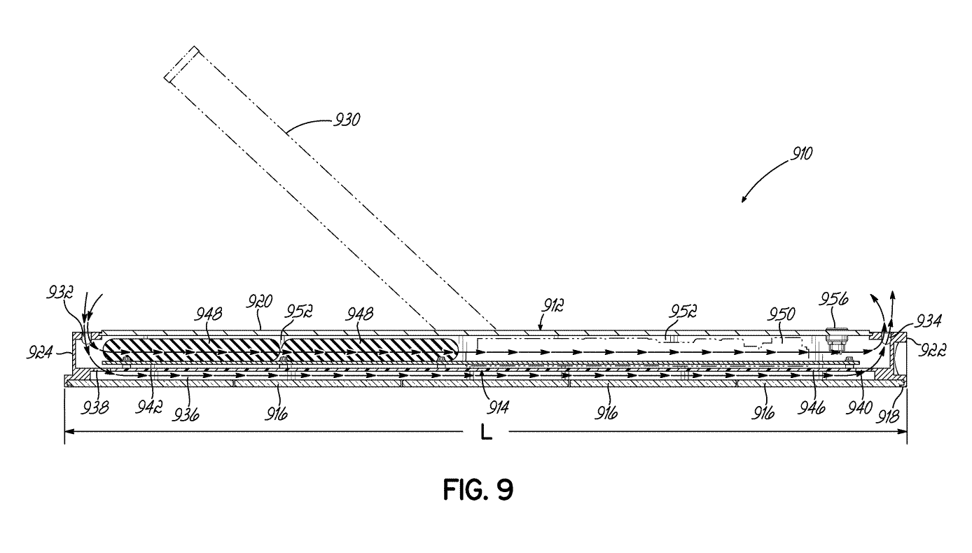

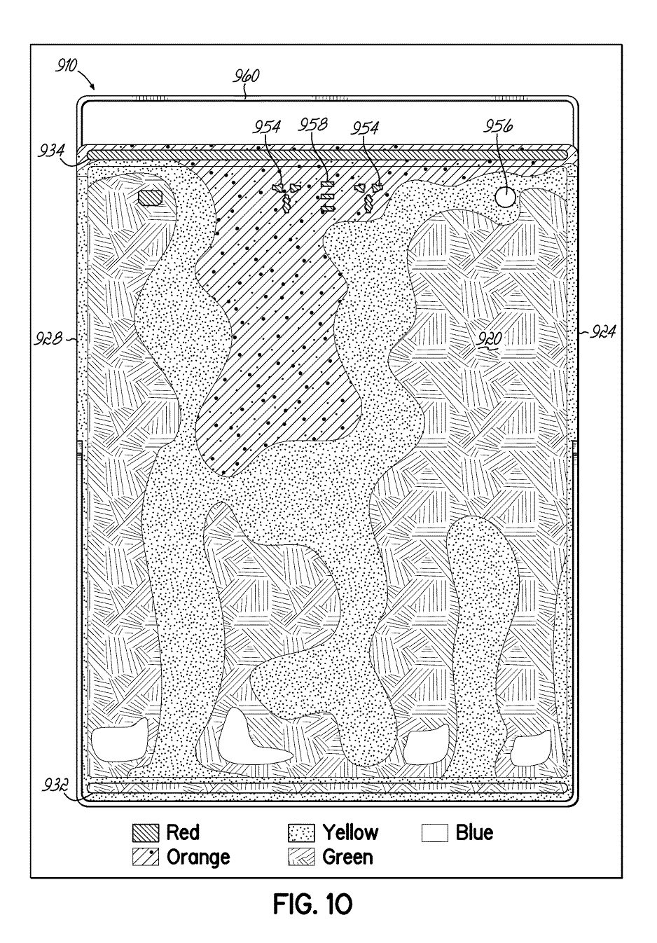

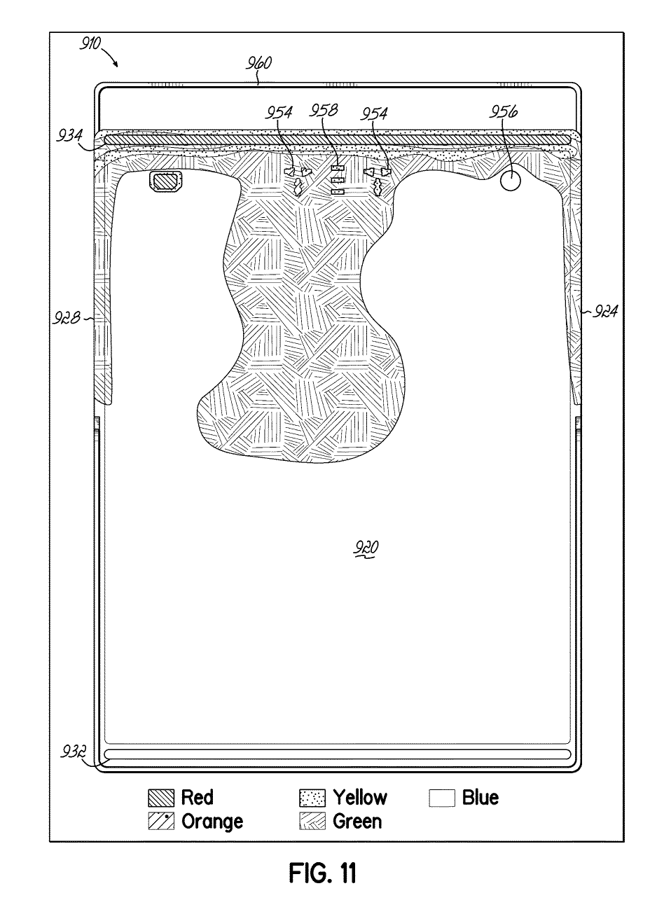

FIG. 9-11 illustrate an exemplary embodiment of a solar panel 910, with various structural components being shown and described in detail. As shown in FIG. 9, the solar panel 910 includes a housing 912, a heat shield 914 disposed within the housing 912, and a plurality of solar cells 916. The housing 912 includes a front surface 918, a back surface 920 disposed opposite the front surface 918, a top surface 922, a bottom surface 924, and left and right side surfaces 926, 928 (shown in FIGS. 10 and 11). Persons skilled in the art would appreciate that the front and back surfaces 918, 920 may each include one or more surfaces that together combine to form the respective front and back surfaces 918, 920. The housing 912 also includes an adjustable tilt mechanism 930 configured to allow the solar panel 910 to be adjustably positioned relative to the position of the sun for optimal collection of solar energy. The plurality of solar cells 916 are disposed adjacent the front surface 918 of the housing 912 and may be attached to the housing 912 using any suitable attachment method.

With reference to the cross-sectional view of FIG. 9, the housing 912 includes an air inlet 932 configured to allow air to enter the housing 912 and an air outlet 934 configured to allow the air to exit the housing 912. As shown in FIG. 9, both the air inlet 932 and the air outlet 934 are disposed on the back surface 920 of the housing 912. However, persons skilled in the art would appreciate that the air inlet 932 and/or the air outlet 934 may be disposed on other surfaces of the housing 912, such as the top surface 922 or the bottom surface 924. As shown in FIGS. 10 and 11, the air inlet 932 has a first diameter and the air outlet 934 has a second diameter, with the second diameter being greater than the first diameter. However, persons skilled in the art would also appreciate that the first diameter may alternatively be the same or even greater than the second diameter.

With continued reference to FIG. 9, a first air channel 936 fluidly communicates with the air inlet 932 and the air outlet 934. The first air channel 936 is disposed within the housing 912 between the heat shield 914 and the front surface 918. As shown in FIG. 9, the first air channel 936 may extend in a direction generally parallel to both the heat shield 914 and the plurality of solar cells 916. The first air channel 936 preferably extends along at least 50% of the lengthwise direction (L) of the solar panel 910, and more preferably extends along at least 75% of the lengthwise direction of the solar panel 910. According to an exemplary embodiment, the first air channel 936 is about 0.25 inches; however, persons skilled in the art would appreciate that any suitable range of dimensions may be used.

The housing 912 may include first and second apertures 938, 940. The first aperture 938 is disposed adjacent a first portion 942 of the heat shield 914 and is configured to allow air to enter the first portion of the first air channel 936. The second aperture 940 is disposed adjacent a second portion 946 of the heat shield 914 and is configured to allow the air to exit the second portion of the first air channel 936.

The heat shield 914 enables the air from the back surface 920 of plurality of solar cells 916 to be separated from the plurality of batteries 948 and the electronics 950 (shown using dashed lines), which may generate their own electrical heat. With continued reference to FIG. 9, the heat shield 914 is disposed within the housing 912 and is configured to reduce the heat transfer between the front and back surfaces 918, 920 of the housing 912. The heat shield 914 may include first and second planar surfaces, and a plurality of honeycomb shaped structures disposed between the first and second planar surfaces. The plurality of honeycomb shaped structures are configured to reduce the heat transfer between the front and back surfaces 918, 920 of the housing 912.

With continued reference to FIG. 9, a second air channel 952 may fluidly communicate with the air inlet 932 and the air outlet 934. The second air channel 952 may be disposed between the heat shield 914 and the back surface 920 and be configured to dissipate heat from the electronics 950 and the plurality of batteries 948 through the air outlet 934.

An exemplary method of removing heat from a solar panel 910 will now be described. The method includes positioning a heat shield 914 within the housing 912 to reduce the heat transfer between the front and back surfaces 918, 920. The method also includes intaking air through the air inlet 932 into the first air channel 936 disposed between the heat shield 914 and the plurality of solar cells 916. The method also includes flowing the air through the first air channel 936 causing the air to increase in temperature. The method also includes exhausting the air from the first air channel 936 through the air outlet 934 to dissipate heat from the plurality of solar cells 916. The air may enter through the air inlet 932 into a second air channel 952 disposed between the heat shield 914 and the back surface 920. The air may flow through the second air channel 952 causing the air to increase in temperature.

The electronics 950 (including the motherboard) and the plurality of batteries 948 may be disposed between the heat shield 914 and the back surface 920. The air may be exhausted from the first air channel 936 through the air outlet 934 to dissipate heat from the electronics 950 and the plurality of batteries 948. The heat from produced by the plurality of solar cells 916, electronics 950 and the batteries 948 may be merged prior to being exhausted through the air outlet 934.

According to an exemplary embodiment, the housing 912 may be formed exclusively of aluminum to aid in the heat dissipation from the plurality of solar cells 916, the electronics 950, and/or the plurality of batteries 948. Using aluminum also allows the handle 960 (shown in FIGS. 10 and 11) to stay cool and allow the solar panel 910 to be carried from location to location. The aluminum also helps to dissipate the heat from the plurality of solar cells 916 and potentially enable them to operate more efficiently.

FIGS. 10 and 11 respectively show thermal images of the back surface 920 of the solar panel 910 at two times after being removed from the sunlight. Five different thermal regions are shown (in order of decreasing temperature): a red region, an orange region, a yellow region, a green region, and a blue region. FIGS. 10 and 11 show the solar panel 910 running a 650 Watt load. As shown in FIGS. 10 and 11, the back surface 920 includes power outlets 954, a power button 956, and USB outlets 958.

FIG. 10 shows a first thermal image of the back surface 920 of the solar panel 910 just after being removed from the sunlight, after being located in the sunlight for a few hours. As shown, the air inlet 932 is depicted as a green region, while the air outlet 934 is shown by a red region, indicating that heat is dissipating through the air outlet 934. This allows the plurality of solar cells 916 stay as cool as possible, while simultaneously preventing heat from being conducted into the electronics 950 and/or the batteries 948. The generally vertically extending yellow regions near the lower portion of the back surface 920 shows the heat near the batteries 948, while the orange region near the upper portion of the back surface 920 shows heat generated by the electronics 950. The power button 956 is shown by a blue region.

FIG. 11 shows another thermal image the back surface 920 of the solar panel 910 at a period of time after FIG. 10. As shown, the cooler blue region encompasses much of the back surface 920. The air outlet 934 is shown by a red region, indicating that heat is still dissipating through the air outlet 934. The power outlets 954 and USB outlets 958 are shown as an orange region.

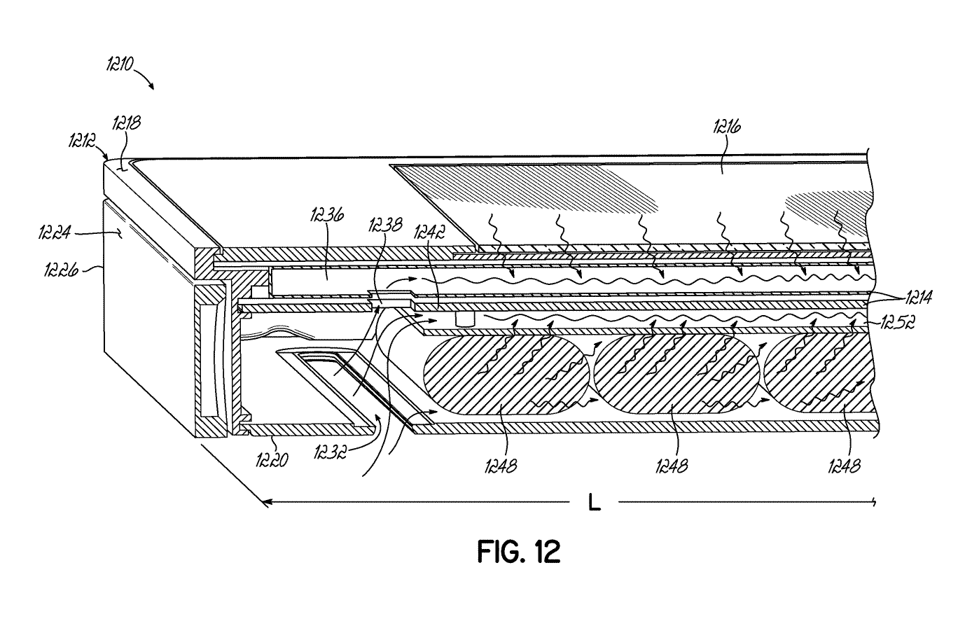

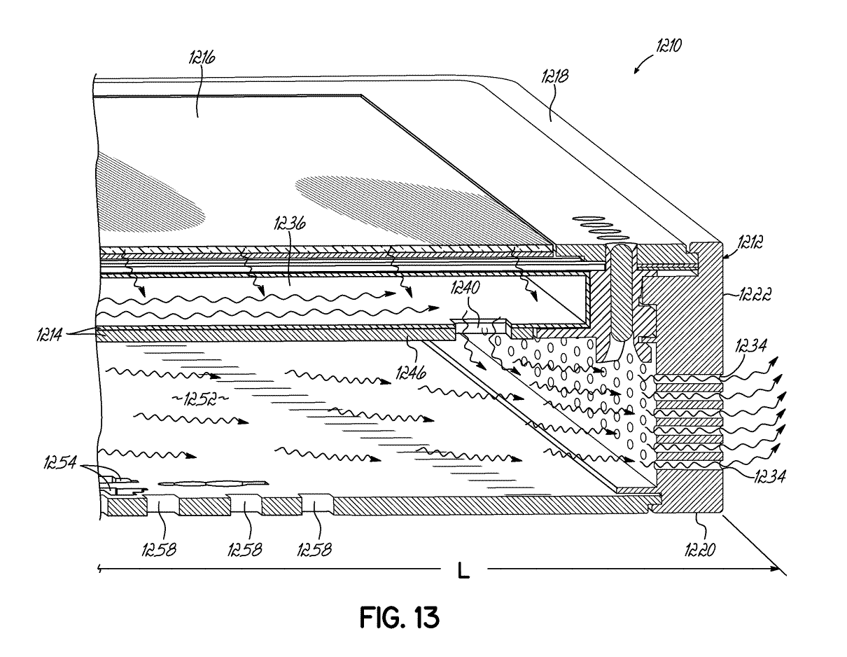

With reference to FIGS. 12 and 13, another embodiment of a solar panel 1210 in accordance with this invention is shown in detail. This solar panel 1210 includes many of the same elements as the previously described embodiment (solar panel 910), and these elements have been provided with similar reference numbers in the 1200 series where the elements are substantially similar or identical. For example, the solar panel of this embodiment again includes a housing 1212, a heat shield 1214, a plurality of solar cells 1216, a front surface 1218, a back surface 1220, a top surface 1222, a bottom surface 1224, a left side surface 1226, an air inlet 1232, an air outlet 1234, a first air channel 1236, a first aperture 1238, a second aperture 1240, a first portion 1242, a second portion 1246, a plurality of batteries 1248, a second air channel 1252, power outlets 1254, and USB outlets 1258. Although some of these elements have slightly modified shapes or profiles in this embodiment, the solar panel 1210 and its elements function as described above (the detailed description of these identical or substantially similar elements is largely not repeated herein for the sake of brevity).

The flow of air from the air inlet 1232 into the first and second air channels 1236, 1252 are shown using wavy arrows. A heat shield 1214 separates the first and second air channels 1236, 1252. The air enters the first air channel 1236 through a first aperture 1238 at a first portion 1242 of the heat shield 1214 and exits the first air channel 1236 through a second aperture 1240 at a second portion 1246 of the heat shield 1214.

While FIGS. 9-13 show and describe the solar panel 910, 1210 being portable, many of the principles of this invention also apply to permanent solar panels (not shown) affixed to a structure, such as to a residential or commercial building.

### CONCLUSION

It is to be appreciated that the Detailed Description section, and not the Abstract section, is intended to be used to interpret the claims. The Abstract section may set forth one or more, but not all exemplary embodiments, of the present disclosure, and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made without departing from the spirit and scope of the present disclosure. Thus the present disclosure should not be limited by any of the above-described exemplary embodiments, but should be defined only in accordance with the following claims and their equivalents.

What is claimed is:

1. A solar panel comprising:
a housing including:
a front surface;
a back surface disposed opposite the front surface;
an air inlet configured to allow air to enter the housing;
an air outlet configured to allow the air to exit the housing; and
a first air channel fluidly communicating with the air inlet and the air outlet;
a heat shield disposed within the housing and configured to reduce heat transfer between the front and back surfaces of the housing; and
a plurality of solar cells disposed adjacent the front surface of the housing,
wherein the first air channel is disposed within the housing between the heat shield and the front surface.

2. The solar panel of claim 1, further comprising:
electronics and a plurality of batteries disposed between the heat shield and the back surface; and
a second air channel fluidly communicating with the air inlet and the air outlet and being disposed between the heat shield and the back surface, the second air channel being configured to dissipate heat from the electronics and the plurality of batteries through the air outlet.

3. The solar panel of claim 1, wherein the heat shield further comprises:
first and second planar surfaces; and
a plurality of honeycomb shaped structures disposed between the first and second planar surfaces and configured to reduce the heat transfer between the front and back surfaces of the housing.

4. The solar panel of claim 1, wherein the housing further comprises:
a first aperture disposed adjacent a first end of the heat shield and configured to allow the air to enter a first end of the first air channel; and
a second aperture disposed adjacent a second end of the heat shield and configured to allow the air to exit a second end of the first air channel.

5. The solar panel of claim 1, wherein the housing is exclusively formed from aluminum to further dissipate heat from the plurality of solar cells, the electronics, and the plurality of batteries.

6. The solar panel of claim 1, wherein first air channel the extends in a direction generally parallel to both the heat shield and the plurality of solar cells.

7. The solar panel of claim 1, wherein the first air channel extends along at least 50% of the lengthwise direction of the solar panel, and preferably along at least 75% of the lengthwise direction of the solar panel.

8. The solar panel of claim 1, wherein both the air inlet and the air outlet are disposed on the rear surface of the housing.

9. The solar panel of claim 1, wherein the air inlet has a first diameter and the air outlet has a second diameter that is greater than the first diameter.

10. The solar panel of claim 1, wherein the housing further comprises an adjustable tilt mechanism configured to allow the solar panel to be adjustably positioned relative to the sun for optimal solar energy collection.

11. A method of removing heat from a solar panel, the solar panel including a housing including a front surface, a back surface disposed opposite the front surface, an air inlet and an air outlet, and a plurality of solar cells disposed adjacent the front surface of the housing, the method comprising:
positioning a heat shield within the housing to reduce the heat transfer between the front and back surfaces;
intaking air through the air inlet into the first air channel disposed between the heat shield and the plurality of solar cells;
flowing the air through the first air channel causing the air to increase in temperature; and
exhausting the air from the first air channel through the air outlet to dissipate heat from the plurality of solar cells.

12. The method of claim 11 wherein:
the intaking step further comprises intaking the air through the air inlet into a second air channel disposed between the heat shield and the back surface;
the flowing step further comprises flowing the air through the second air channel causing the air to increase in temperature; and
the exhausting step further comprises exhausting the air from the first air channel through the air outlet to dissipate heat from the electronics and the plurality of batteries.

13. The method of claim 11, wherein the flowing step further comprises flowing the air through the first air channel that extends in a direction generally parallel to both the heat shield and the plurality of solar cells.
